(19) United States
(12) Patent Application Publication
(10) Pub. No.: US 2018/0173686 A1
(43) Pub. Date: Jun. 21, 2018

(54) SYSTEM AND METHOD FOR DISPLAYING GRAPHIC-BASED WEB VECTOR MAP

(71) Applicant: HYUNDAI MNSOFT, INC., Seoul (KR)

(72) Inventors: Jin Young KWON, Seoul (KR); Hyun Do JUNG, Seoul (KR); Hong Seok KIM, Seoul (KR); Sun Mi SEO, Seoul (KR); Yeon Hee PARK, Seoul (KR)

(73) Assignee: HYUNDAI MNSOFT, INC., Seoul (KR)

(21) Appl. No.: 15/736,739

(22) PCT Filed: Nov. 6, 2015
(86) PCT No.: PCT/KR2015/011942

§ 371 Date: Dec. 14, 2017

(30) Foreign Application Priority Data
Jun. 30, 2015 (KR) 10-2015-0092897

(51) Int. Cl. G06F 17/22; G06F 17/30

(52) U.S. Cl. CPC G06F 17/2264; G06F 17/2247; G06F 17/30896

(57) ABSTRACT

A graphics-based web vector map display method may include: extracting object information from map sheet information of a previously stored original vector map; extracting an input array of a display engine for each type of the original vector map; storing the object information in the extracted input array of the display engine; separating the input array having the object information stored therein into property layer arrays according to property information of map information; storing the separated property layer arrays as map sheet information of a web-based vector map; and generating service-specific vector map information from the map sheet file of the web-based vector map.

### CROSS-REFERENCE(S) TO RELATED APPLICATIONS

The present application is a U.S. National Phase entry of International Patent Application No. PCT/KR2015/011942, filed Nov. 6, 2015, which claims priority to Korean Patent Application No. 10-2015-0092897, filed Jun. 30, 2015, the entire contents of which are incorporated herein for all purposes by this reference.

### TECHNICAL FIELD

The present invention relates to a graphics-based web vector map display method, and more particularly, to a graphics-based web vector map display method which includes extracting object information from vector map sheet information, extracting an input array of a display engine for each map type, storing the object information in the extracted input array of the display engine, and storing the input array as a map sheet file.

### BACKGROUND ART

Recently, the technique of three-dimensionally displaying a map on a navigation system has been developed, thereby allowing the navigation system to display a 3D map on the screen thereof. Therefore, a user can recognize a positional relation between the current position and a 3D structure such as a building or intersection point in a 3D manner.

Furthermore, mobile phones such as smart phones have a GPS (Global Positioning System) mounted therein, the GPS enabling a user to recognize the current position. Therefore, a navigation system installed in the mobile phones is utilized in various manners, the navigation system guiding a user with a smart phone to a destination based on the current position of the user.

Moreover, a 3D graphics drawing engine in hardware, capable of drawing 3D graphics on the screens of mobile terminals in real time at high speed, has been commercialized, thereby allowing the portable terminals to draw graphics at high speed.

The increase in memory capacity of navigation systems for vehicles has allowed the negation systems to have a large capacity memory device mounted therein. The large capacity memory device stores high volume data such as 3D map data such that the data can be accessed at high speed.

Recently, mobile terminals such as smart phones or vehicle navigation systems have a communication function of transmitting map data to a user terminal through communication. However, the size of transmittable data is limited due to a heavy communication fee. Thus, the data are used only to process a simple service for expressing tracking objects.

Related Art Document: Korean Patent Registration No. 10-1157581

### Technical Problem

Embodiments of the present invention are directed to a graphics-based web vector map display system and method capable of displaying a high-volume vector map on a web page, thereby removing a limitation in performance and capacity of a vector map.

Also, embodiments of the present invention are directed to a graphics-based web vector map display system and method capable of extracting object information from vector map sheet information, extracting an input array of a display engine for each map type, storing the object information in the extracted input array of the display engine, and storing the input array as a map sheet file of a vector display to be provided.

### Technical Solution

In an embodiment, a graphics-based web vector map display method may include: extracting object information from map sheet information of a previously stored original vector map; extracting an input array of a display engine for each type of the original vector map; storing the object information in the extracted input array of the display engine; separating the input array having the object information stored therein into property layer arrays according to property information of map information; storing the separated property layer arrays as map sheet information of a web-based vector map; and generating service-specific vector map information from the map sheet file of the web-based vector map.

The original vector map may be formed in a JSON (JavaScrip Object Notation) format.

The display engine may include a canvas engine or WebGL (Web Graphics Library) engine implemented on the web.

The input array of the display engine may be generated through data parsing and processing for the previously stored original vector map, as an input value of the canvas engine or WebGL engine, and the data of the vector map, utilized for the parsing and processing, may be removed after the parsing and processing.

The object information may include one or more of point information, line information, surface information, coordinate string information and RGB color information of the previously stored original vector map.

The service-specific vector map information may be formed in the HTML5 format.

The graphics-based web vector map display method may further include providing one or more pieces of service vector map information through a web page connected to an external terminal device, the one or more pieces of service vector map information corresponding to a request of the external terminal device in the generated service-specific vector map information.

In another embodiment, a graphics-based web vector map display system may include: an external terminal device connected to a web page which provides a web-based vector map; and an electron device. The electronic device may include: a vector map service unit configured to transmit/receive data to/from one or more external terminal devices; a storage unit configured to store an original vector map for generating a web-based vector map; a display engine unit configured to display the web-based vector map on a web page to which the external terminal device is connected, according to a control signal of the vector map service unit; and a vector map data generation unit configured to extract object information from map sheet information of the previously stored original vector map, extract an input array of the display engine from each type of the original vector map, store the extracted object information in the extracted input array of the display engine, separate the input array having the object information stored therein into property layer arrays according to property information of map information, store the separated property layer arrays as map sheet information of the web-based vector map, and generate service-specific vector map information from the map sheet file of the web-based vector map.

### Advantageous Effects

According to the embodiments of the invention, since the vector map and the storage array structure of the display engine are coupled, the graphics-based web vector map display system and method can remove unnecessary elements after an operation process, thereby reducing the data size.

Furthermore, the graphics-based web vector map display system and method can remove a limitation in performance and capacity of a vector map, and display a large-volume vector map on the web.

### DESCRIPTION OF DRAWINGS

FIG. 1 illustrates a graphics-based web vector map display system in accordance with an embodiment of the present invention.

FIG. 2 illustrates a detailed structure of a vector map in accordance with the embodiment of the present invention.

FIG. 3 illustrates a process of generating the vector map in accordance with the embodiment of the present invention.

FIG. 4 illustrates a text-based JSON format map in accordance with the embodiment of the present invention.

FIG. 5 illustrates a display engine in accordance with the embodiment of the present invention.

FIG. 6 illustrates an example of a map service to be used by a user in accordance with the embodiment of the present invention.

FIG. 7 illustrates map services depending on the types of user terminal devices in accordance with the embodiment of the present invention.

FIG. 8 illustrates a graphics-based web vector map display method in accordance with an embodiment of the present invention.

### BEST MODEL

Hereafter, exemplary embodiments of the present invention will be described in detail with reference to the accompanying drawings. However, the present invention is not limited to the exemplary embodiments. Like reference numerals in the respective drawings represent components to perform substantially the same functions.

Terms including ordinal numbers such as first and second may be used for describing various components, but the components are not limited by the terms. The terms are used only to distinguish one component from another component. For example, a first component may be referred to as a second component within the scope of the present invention, and the second component may be referred to as the first component. The terms used in this specification are used only to describe a specific embodiment, and do not limit the present invention. The terms of a singular form may include plural forms unless referred to the contrary.

In this specification, general terms which are widely used nowadays are selected as the terms used herein in consideration of functions in the present invention. However, the terms may be changed depending on an appearance of a precedent or new technique or the intention of a person skilled in the art. In a specific case, a term selected by the present applicant may be used. In this case, the meaning of the term will be described in detail in the corresponding part of this specification. Therefore, the definition of the terms used herein should not be made by the names of the terms, but made by the meanings of the terms based on the overall disclosures set forth herein.

Throughout the specification, when an element “includes” a component, it may indicate that the element does not exclude another component unless referred to the contrary, but can further include another component.

In the following embodiments of the present invention, a user terminal device may indicate an arbitrary electronic device having a display unit such as a touch screen, and may be referred to as a portable terminal, mobile terminal, communication terminal or portable mobile terminal. For example, the electronic device may include a smart phone, a mobile phone, a navigation system, a head unit for vehicles, a tablet computer, a flexible device, a flexible display device and the like.

1. Graphics-Based Web Vector Map Display System

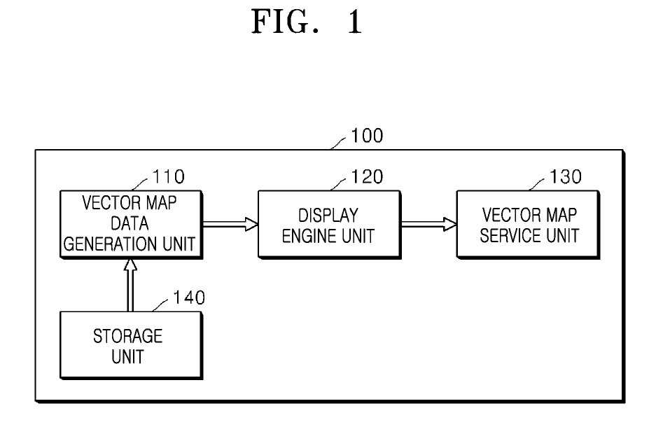

FIG. 1 illustrates a graphics-based web vector map display system in accordance with an embodiment of the present invention.

Referring to FIG. 1, the graphics-based web vector map display system 100 in accordance with the embodiment of the present invention may include a vector map data generation unit 110, a display engine unit 120 and a vector map service unit 130.

The vector map data generation unit 110 may generate web-based vector maps from a previously stored original vector map.

The vector map service unit 130 may receive a service request signal from one or more user terminal devices (not illustrated) connected to a vector map web page on the web in service.

Then, the vector map service unit 130 may provide vector map information belonging to a service corresponding to the received service request signal among the web-based vector maps generated by the vector map data generation unit 110, such that the vector map information can be displayed on the vector map web page on the web through the display engine unit 120.

2. Web-Based Vector Map

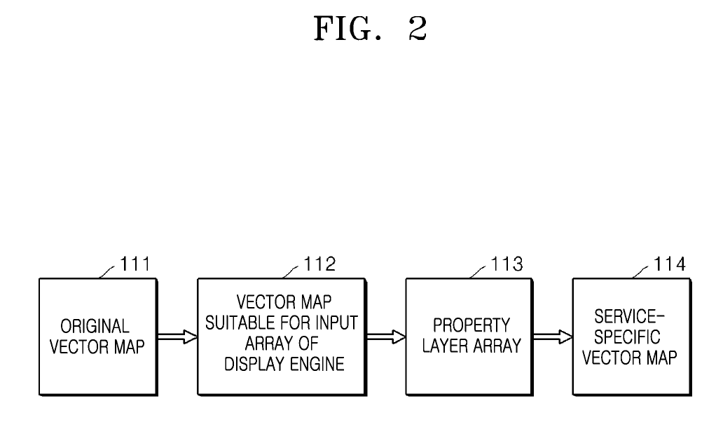

FIG. 2 illustrates a detailed structure of a web-based vector map in accordance with the embodiment of the present invention.

Referring to FIG. 2, the web-based vector map in accordance with the embodiment of the present invention may be generated through the following process.

First, the vector map data generation unit 110 may generate a graphics-based vector map 112 as a property layer array 113 from the previously stored original vector map 111, the vector map 112 corresponding to a display engine input array.

Then, the vector map data generation unit 110 may generate service-specific vector map information 114 from the generated property layer array 113.

More specifically, FIG. 4 illustrates a text-based JSON (JavaScrip Object Notation) format map in accordance with the embodiment of the present invention.

Referring to FIG. 4, the vector map data generation unit 110 in accordance with the embodiment of the present invention may generate web-based vector maps from the original vector map stored in a storage unit 140.

The original vector map stored in the storage unit in accordance with the embodiment of the present invention may include map sheet information of web-based vector maps which will be finally generated, and may be constructed in the JSON format by a text-based language.

Furthermore, the JSON format data constituting the original vector map stored in the storage unit in accordance with the embodiment of the present invention may include text-based data such as objects, arrays, values, strings and numbers.

The JSON format data constituting the original vector map stored in the storage unit in accordance with the embodiment of the present invention may include one or more objects which can be divided for each service.

3. Vector Map Data Generation Unit

The vector map data generation unit 110 in accordance with the embodiment of the present invention may extract object information from the map sheet information of the original vector map stored in the storage unit.

Then, the vector map data generation unit 110 may extract an input array of a display engine used in the display engine unit 120.

Then, the vector map data generation unit 110 may store the object information in the extracted input array of the display engine, the object information being extracted from the map sheet information of the original vector map stored in the storage unit.

More specifically, the vector map data generation unit 110 may store point information, line information, surface information and coordinate string information in the extracted input array of the display engine, as the object information extracted from the map sheet information of the previously stored original vector map.

Furthermore, the vector map data generation unit 110 may store RGB color information in the extracted input array of the display engine, as the object information extracted from the map sheet information of the previously stored original vector map.

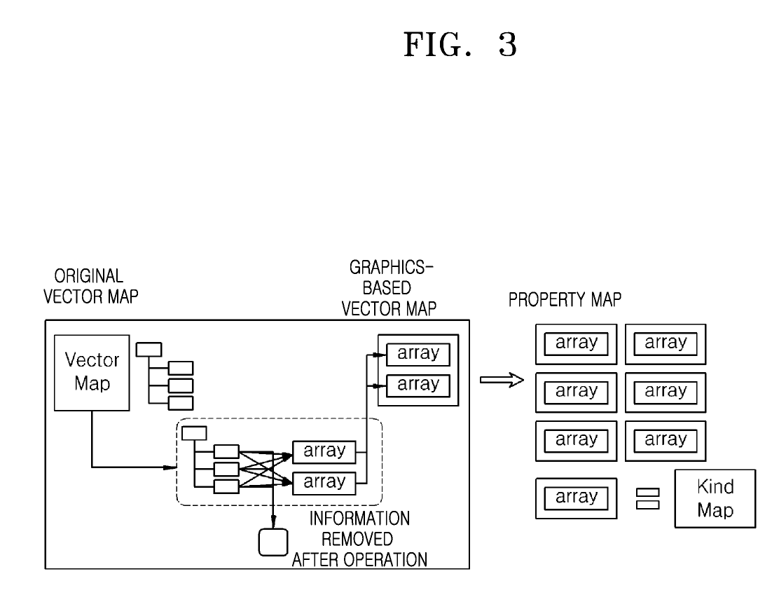

At this time, the object information may be stored in the input array of the display engine, extracted through processes illustrated in FIG. 3. FIG. 3 illustrates the process of generating the vector map in accordance with the embodiment of the present invention.

Referring to FIG. 3, the vector map data generation unit 110 in accordance with the embodiment of the present invention may extract input array suitable for the display engine used in the display engine unit 120. That is, the vector map data generation unit 110 may extract input array suitable for a canvas engine or WebGL (Web Graphics Library) engine.

Then, the vector map data generation unit 110 may parse and process the object information which is the JSON format data extracted from the original vector map stored in the storage unit, such that the object information corresponds to the input array of the display engine.

Then, the vector map data generation unit 110 may store the parsed and processed object information in the extracted input array of the display engine in order to construct service-specific vector map information.

The object information of the vector map used for the parsing and processing in accordance with the embodiment of the present invention may be removed after the parsing and processing.

Then, the vector map data generation unit 110 may separate the input array having the object information stored therein into property layer arrays according to the property information of the map information.

Then, the vector map data generation unit 110 may store the separated property layer arrays as the map sheet information of the web-based vector map.

Then, the vector map data generation unit 110 may generate service-specific vector map information from the map sheet file of the web-based vector map.

The service-specific vector map information generated by the vector map data generation unit 110 in accordance with the embodiment of the present invention may include vector maps on the web, which are formed in the HTML5 format.

4. Display Engine Unit

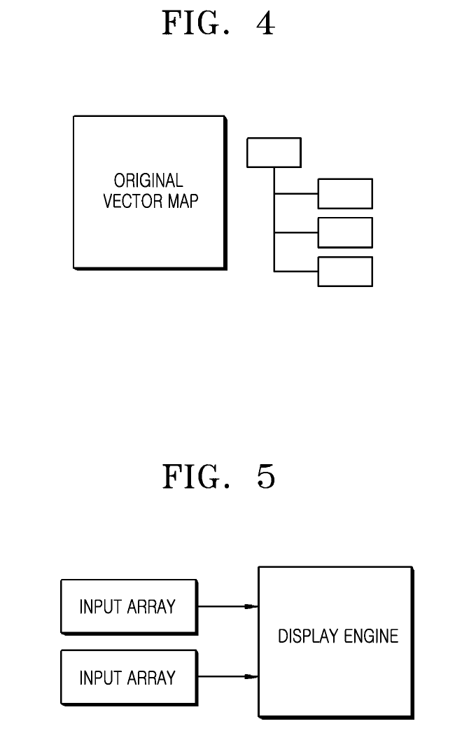

FIG. 5 illustrates the display engine in accordance with the embodiment of the present invention.

Referring to FIG. 5, the display engine unit 120 in accordance with the embodiment of the present invention may have a function of displaying the web-based vector map generated by the vector map data generation unit 110 on a web page according to control of the vector map service unit 130.

More specifically, the display engine unit 120 may use a canvas engine or WebGL engine as the display engine, the canvas engine or WebGL engine being supported by the HTML5.

5. Vector Map Service Unit

The vector map service unit 130 may receive a service request signal from one or more user terminal devices (not illustrated) connected to a vector map web page on the web in service.

Then, the vector map service unit 130 may provide vector map information belonging to a service corresponding to the received service request signal among the web-based vector maps generated by the vector map data generation unit 110, such that the vector map information can be displayed on the vector map web page on the web through the display engine unit 120.

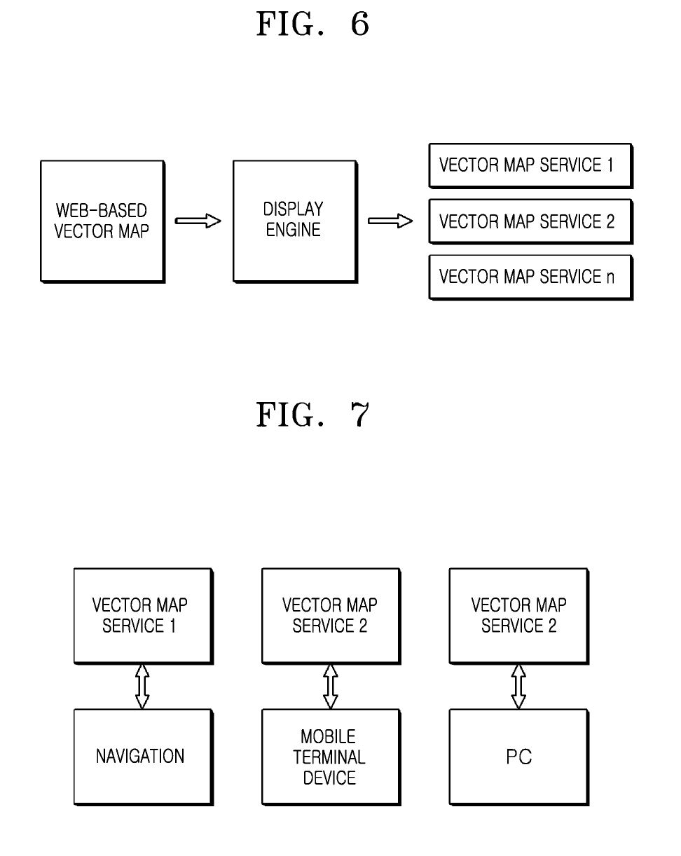

More specifically, FIG. 6 illustrates an example of a map service to be used by a user in accordance with the embodiment of the present invention, and FIG. 7 illustrates map services depending on the types of user terminal devices in accordance with the embodiment of the present invention.

Referring to FIGS. 6 and 7, the vector map service unit 130 in accordance with the embodiment of the present invention may provide a vector map belonging to a service corresponding to a service request signal received from one or more user terminal devices (not illustrated), such that the vector map can be displayed on a vector map web page displayed on a display unit (not illustrated) of the corresponding user terminal device through the display engine unit 120.

As illustrated in FIG. 7, the user terminal devices (not illustrated) may include a navigation system, a mobile terminal device and a personal computer (PC) and the like. The external user terminal devices may receive a web-based vector map provided by the vector map service unit 130 through display units installed therein. The web-based vector map belonging to the service provided by the vector map service unit 130 may include one or more web-based vector maps among the plural pieces of service-specific vector map information generated by the vector map data generation unit 110.

6. Web-Based Vector Map Display Method

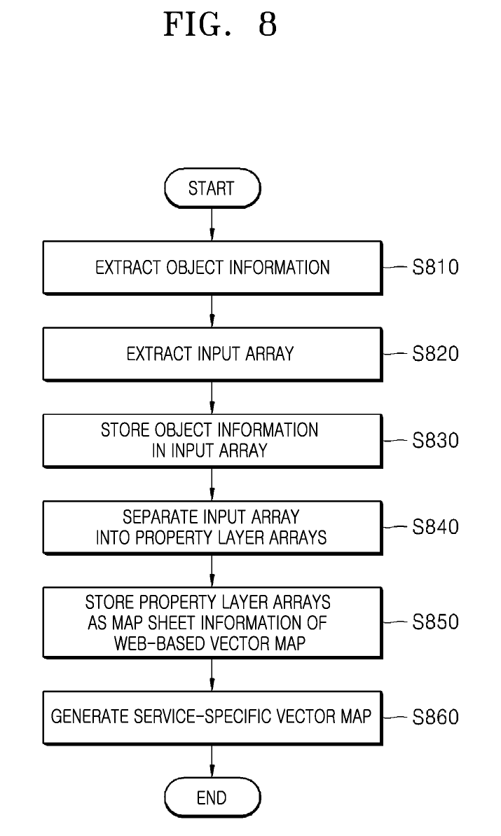

FIG. 8 illustrates a graphics-based web vector map display method in accordance with an embodiment of the present invention.

Referring to FIG. 8, the vector map data generation unit 110 of the web vector map display system 100 in accordance with the embodiment of the present invention may extract object information from map sheet information of a previous stored original vector map at step S810.

Then, the vector map data generation unit 110 may extract an input array of the display engine used in the display engine unit 120 at step S820.

Then, the vector map data generation unit 110 may store the object information in the extracted input array of the display engine at step S830.

Then, the vector map data generation unit 110 may separate the input array having the object information stored therein into property layer arrays according to the property information of the map information at step S840.

Then, the vector map data generation unit 110 may store the separated property layer arrays as the map sheet information of the web-based vector map at step S850.

Then, the vector map data generation unit 110 may generate service-specific vector map information from the map sheet file of the web-based vector map according to a control signal of the vector map service unit 130 at step S860.

The web vector map display method in accordance with the embodiment of the present invention may further include providing one or more pieces of service vector map information through a web page connected to an external terminal device, and the one or more pieces of service vector map information may correspond to a request of the external terminal device among the plural pieces of service-specific vector map information generated by the vector map data generation unit 110.

The terms used in the specification are generally intended as “open” terms in claims. For example, when an element is referred to as “comprising” a component, it may indicate that the element comprises the component, but is not limited to the component. Furthermore, when an element is referred to as “having” a component, it may indicate that the element has at least the component and can include other components. When a specific number is intended in claims, the intention is clearly described in the corresponding claims. When the descriptions are not present, it may indicate that such an intention is not present.

Although some embodiments have been provided to illustrate the invention in conjunction with the drawings, it will be apparent to those skilled in the art that the embodiments are given by way of illustration only, and that various modifications and equivalent embodiments can be made without departing from the spirit and scope of the invention. The scope of the invention should be limited only by the accompanying claims.

What is claimed is:

1. A graphics-based web vector map display method comprising:
extracting object information from map sheet information of a previously stored original vector map;
extracting an input array of a display engine for each type of the original vector map;
storing the object information in the extracted input array of the display engine;
separating the input array having the object information stored therein into property layer arrays according to property information of map information;
storing the separated property layer arrays as map sheet information of a web-based vector map; and
generating service-specific vector map information from the map sheet file of the web-based vector map.

2. The graphics-based web vector map display method of claim 1, wherein the original vector map is formed in a JSON (JavaScrip Object Notation) format.

3. The graphics-based web vector map display method of claim 1, wherein the display engine comprises a canvas engine or WebGL (Web Graphics Library) engine implemented on the web.

4. The graphics-based web vector map display method of claim 1, wherein the input array of the display engine is generated through data parsing and processing for the previously stored original vector map, as an input value of the canvas engine or WebGL engine, and the data of the vector map, utilized for the parsing and processing, are removed after the parsing and processing.

5. The graphics-based web vector map display method of claim 1, wherein the object information comprises one or more of point information, line information, surface information, coordinate string information and RGB color information of the previously stored original vector map.

6. The graphics-based web vector map display method of claim 1, wherein the service-specific vector map information is formed in the HTML5 format.

7. The graphics-based web vector map display method of claim 1, further comprising providing one or more pieces of service vector map information through a web page connected to an external terminal device, the one or more pieces of service vector map information corresponding to a request of the external terminal device in the generated service-specific vector map information.

8. A graphics-based web vector map display system comprising:
an external terminal device connected to a web page which provides a web-based vector map; and
an electron device,
wherein the electronic device comprises:
a vector map service unit configured to transmit/receive data to/from one or more external terminal devices;
a storage unit configured to store an original vector map for generating a web-based vector map;
a display engine unit configured to display the web-based vector map on a web page to which the external terminal device is connected, according to a control signal of the vector map service unit; and
a vector map data generation unit configured to extract object information from map sheet information of the previously stored original vector map, extract an input array of the display engine from each type of the original vector map, store the extracted object information in the extracted input array of the display engine, separate the input array having the object information stored therein into property layer arrays according to property information of map information, store the separated property layer arrays as map sheet information of the web-based vector map, and generate service-specific vector map information from the map sheet file of the web-based vector map.

9. The graphics-based web vector map display system of claim 8, wherein the original vector map is formed in the JSON format.

10. The graphics-based web vector map display system of claim 8, wherein the display engine comprises a canvas engine or WebGL engine implemented on the web.

11. The graphics-based web vector map display system of claim 8, wherein the input array of the display engine is generated as an input value of the canvas engine or WebGL engine through an operation of parsing and processing the data of the previously stored original vector map, and the data of the vector map, utilized for the parsing and processing, are removed after the parsing and processing.

12. The graphics-based web vector map display system of claim 8, wherein the object information comprises one or more of point information, line information, surface information, coordinate string information and RGB color information of the previously stored original vector map.

13. The graphics-based web vector map display system of claim 8, wherein the service-specific vector map information is formed in the HTML5 format.
